(19) United States
(12) Patent Application Publication
(10) Pub. No.: US 2024/0342913 A1
(43) Pub. Date: Oct. 17, 2024

(54) METHOD FOR MONITORING THE OPERATION OF A ROBOT

(71) Applicant: SICK AG, Waldkirch (DE)

(72) Inventors: Christoph HOFMANN, Waldkirch (DE); Markus HAMMES, Freiburg (DE)

(21) Appl. No.: 18/636,603

(22) Filed: Apr. 16, 2024

(30) Foreign Application Priority Data
Apr. 17, 2023 (EP) 23168278.2

(51) Int. Cl. B25J 9/16

(52) U.S. Cl. CPC B25J 9/1676; B25J 9/1605

(57) ABSTRACT

The present invention relates to a method for monitoring the operation of a robot, in particular an articulated arm robot having, for example, 6 axes, in a protective field, wherein the protective field has an outer boundary, wherein
a respective space occupied by the robot is determined for different robot positions,
the space occupied by the robot in the respective robot position is removed from the protective field, wherein an inner boundary of the protective field is created and/or changed by removing the occupied space.

The present invention relates to a method for monitoring the operation of a robot, in particular an articulated arm robot having, for example, six axes.

Such robots are often used in industrial processes, for example to perform assembly work, welding work and other work on workpieces. Due to the movements of the robot, it poses a certain danger that is usually countered by access restrictions or by a monitoring of areas near the robot by sensors.

Here, the protective field monitored by the sensors is often positioned relatively far away from the robot so that a violation of the protective field by the robot is avoided. If a violation of the protective field is recognized, for example by a person or even just a body part of a person entering the protective field, the robot is usually stopped, which leads to undesirable production downtimes. The disadvantage of the protective field positioned at a distance from the robot is that space is unnecessarily required for the protective field.

It is therefore an underlying object of the invention to provide an improved method for safeguarding a robot, whereby an improved monitoring of the operation of a robot is ultimately made possible.

This object is satisfied by a method according to claim 1.

The method according to the invention serves to monitor the operation of a robot, in particular an articulated arm robot having, for example, six axes, wherein the robot is operated (at least initially and/or temporarily) in a protective field. The protective field has an outer boundary. In the method,
a respective space occupied by the robot is determined for, in particular a plurality of, different robot positions (e.g. during the movement of the robot),
the space occupied by the robot in the respective robot position is removed from the protective field, wherein an inner boundary of the protective field is created and/or changed (e.g. extended) by removing the occupied space.

The invention is based on the realization that it is very difficult to manually define protective fields that are adapted with a precise fit to the movements of the robot and to enter them into the corresponding software. This in particular applies to articulated arm robots with a large number of axes that can assume complex poses.

According to the invention, the space occupied by the robot is therefore determined at different robot positions during a (real and/or simulated) movement of the robot. The occupied space can, for example, be determined via the external contour of the robot present at the respective point in time. The occupied space can also be approximated so that not every corner and edge of the robot in the current robot position has to be considered when removing the occupied space.

In this respect, it is understood that the occupied space does not refer to the volume, but to the spatial regions in which the robot is located at the respective point in time. The space occupied by the robot (i.e. the spatial region) is then removed from the protective field so that an inner boundary of the protective field results. Removing the occupied space from the protective field results in a cut-out in the protective field that lies within the outer boundary of the protective field. Exactly that spatial region in which the robot is currently located in the respective robot position is thus cut out of the protective field. This is possible with both two-dimensional and three-dimensional protective fields.

Furthermore, it is understood that the robot may also include an end effector moved by the robot (e.g. a tool or a gripper) and/or a workpiece moved or loaded by the robot, i.e. in particular all parts moving along with the robot. Accordingly, the space occupied by the end effector and/or the workpiece can also belong to the space occupied by the robot.

The protective field actually monitored is then the (new or remaining) protective field after the occupied space has been removed and the inner boundary has been created. The protective field therefore extends between the inner boundary and the outer boundary, in particular in different spatial directions.

Figuratively speaking, with a three-dimensional protective field, a kind of bubble can be present inside the protective field that represents the remote region of the protective field.

The (new) protective field generated in this way can then be used in the operation of the robot.

By adapting the inner boundary for different robot positions and “hollowing out” the protective field for the robot in this way, a space is created that is “reserved” for the robot. The protective field does not exist within the inner boundary so that the robot does not trigger a protective field violation during regular operation.

More precisely, the occupied space of the robot is determined and then all the regions that belong to both the protective field and the robot volume (i.e. the space occupied by the robot) are removed from the protective field. The protective field is therefore virtually cut out from the inside, which can, for example, take place through so-called “cutout shapes” that can be defined in configuration software. The robot can in particular be a robot that is firmly anchored to the floor. The outer boundary of the protective field can be predetermined or predefined, for example by the size and/or shape of the space in which the robot performs its movements. The outer boundary of the protective field can be unchangeable. Alternatively, the outer boundary can, however, also be adapted (e.g. to the inner boundary), as explained later.

In particular, the removal of the occupied space from the protective field is performed only once for the respective robot position. In this way, all the different robot positions can then be determined once for predetermined movement sequences and the respective occupied space can be removed from the protective field so that the resulting protective field can then be used during operation.

The removal of the occupied space from the protective field can in particular take place in a teach-in phase in which the robot is moved at a reduced speed and/or stops in the different robot positions in each case. Once the protective field has been finally determined, the robot can enter an operating phase in which the robot carries out its work sequences at normal speed.

According to the invention, it is advantageous that, thanks to the protective field determined in advance (in the teach-in phase), no or only a few changes to the protective field are required during the operating phase of the robot, whereby the monitoring of the operation of the robot is less computationally intensive so that little waste heat is produced and less computing power is required.

Moreover, the invention makes it possible to create precisely fitting protective fields that are also very complex in their shape, which would not be possible manually or only with great effort.

Due to the protective field being adapted to the robot positions, it is finally also possible to recognize errors in the movement of the robot, for example if the robot erroneously moves into the protective field. It can therefore be recognized if the robot violates the protective field from the inside. In particular in the event of a protective field violation, a safety-related measure can be performed, such as a slowing down or stopping of the robot. In this way, the robot coordinates can be made “safe”, whereby the safety when operating the robot is increased.

It is to be understood that the protective field can be a two-dimensional or three-dimensional protective field.

The statement that the robot is operated “in the protective field” is in particular to be understood as the outer boundary of the protective field at least regionally surrounding the robot and/or the protective field safeguarding the robot. By removing the space occupied by the robot, the robot only actually moves in the protective field in the teach-in phase. After the teach-in phase, the robot no longer moves directly in the protective field, but is at least regionally surrounded by the protective field.

As indicated, the robot can be an articulated arm robot, for example a five-axis, six-axis or seven-axis articulated arm robot. A SCARA robot, a Delta robot or a Hexapod robot and other kinds of robots are also possible.

Further embodiments of the invention can be seen from the description, from the drawings, and from the dependent claims.

According to a first embodiment, the robot moves at least partly within the outer boundary of the protective field. The movement can take place in reality or can also be virtual, for example in a simulation, as explained later. The robot is preferably located completely within the outer boundaries of the protective field. The outer boundaries can have the shape of a cuboid, for example.

According to a further embodiment, the space occupied by the robot is (newly) determined in each case after a predetermined time has elapsed and/or in each case after a change in the robot position by a predetermined value. The robot position, i.e. for example the robot pose, i.e. the combination of position and orientation of the components of the robot, can accordingly be determined periodically and/or repeatedly. The determination can, for example, take place several times per second, but also e.g. every 1, 2, 3 or 4 seconds. Alternatively or additionally, a new determination of the robot position and/or the thus associated determination of the space occupied by the robot can take place whenever the robot, and thus in particular at least one of its components, has moved by a predetermined value. The predetermined value can be, for example, a distance and/or an angle of the movement. The distance can amount, for example, to 1, 2, 5 or 10 cm. The angle can e.g. be a joint angle of a joint of the robot. The predetermined value of the angle can e.g. be 1°, 2° or 5°. With kinematically redundant robots, a spatial point of the end effector (so-called TCP—Tool Center Point) can e.g. remain the same, wherein new joint positions can, however, result in a different space being occupied by the robot. After the new determination, the space then occupied is removed from the protective field, i.e. subtracted from the protective field. The spatial region which the protective field then occupies is thus reduced.

According to a further embodiment, the space occupied by the robot between two different robot positions is extrapolated and is also removed from the protective field. An extrapolation between the regions removed from the protective field can therefore take place, for example a linear or polynomial interpolation. In this way, a continuous inner boundary of the protective field can be created.

According to a further embodiment, the protective field is monitored by a sensor system that comprises at least one sensor that is preferably arranged separately and/or spaced apart from the robot. The sensor system can recognize a violation of the protective field. The sensor system can comprise one or more laser scanners, 3D cameras and the like to detect the intrusion or presence of objects in the protective field. The sensor system can preferably comprise several 3D cameras that are mounted at different positions and/or with different orientations so that the protective field is monitored from a plurality of directions. In this way, the protective field can be completely covered by the sensors so that there are no blind areas in the protective field.

According to a further embodiment, the space occupied by the robot is at least partly determined by means of the sensor system, in particular by multiple measurement in the same robot position. Since the sensor system is anyway configured to detect objects within the outer boundary of the protective field, the robot can accordingly also be detected by the sensor system and its current position and the space occupied by the robot can be determined (e.g. measured) by means of the sensor system. The actual robot position, and thus the actually occupied space, can be determined even more precisely by a multiple measurement. For this purpose, a plurality of measurement values can each be offset with one another by averaging or another suitable method.

According to a further embodiment, the space occupied by the robot is at least partly determined by means of simulation, for example by estimation, in particular by means of a Kalman filter. The determination by simulation can take place alternatively or in addition to the detection by the sensor system. The simulation can, for example, take place based on CAD data and/or path planning data, for example, from motion software. For example, data from programs such as ROS (Robot Operating System), in particular MoveIT, or roboDK and similar can be used. In this way, the robot does not necessarily have to execute real movements during the teach-in phase. Instead, the protective field can be adapted purely virtually.

It is also conceivable that unknown robot poses also lead to an adaptation of the protective field during the simulation. For this purpose, possible future robot positions can be estimated, for example starting from a known start robot position, by means of a Kalman filter. The estimation by means of the Kalman filter can take place both in Cartesian space and in joint angle space.

According to a further embodiment, the space occupied by the robot is increased after it has been determined, for example by a stretching, in particular by an isotropic stretching. The increased space can then be removed from the protective field so that the increased space then at least regionally represents the inner boundary of the protective field. In this way, a buffer zone can be created around the robot so that measurement errors or a slight deviation in the robot position during operation do not lead to a protective field violation. For example, the isotropic stretching can increase the space occupied by the robot by 1, 2, 5 or 10% in this case.

Alternatively, the increased space can be used as the new outer boundary of the protective field. In this case, the space occupied by the robot preferably forms the inner boundary of the protective field and/or the increased space forms the outer boundary of the protective field. In this way, a kind of “tube” can be created around the robot, i.e. a protective field adapted to the robot and its movements. If the increased space is to serve as an outer boundary, the occupied space can be increased by 50, 100, 150 or 200%, for example.

In this way, the outer boundary can be defined for a plurality of robot positions such that, for example, a person only has to maintain a small distance from the robot positions. An improved human-machine cooperation can thus be achieved.

The increase in the space occupied by the robot can also be different (for both variants). For example, the increase can be performed in dependence on the robot speed at a specific robot position. Larger buffer zones can, for example, be created around the robot at a high robot speed.

According to a further embodiment, the inner and/or outer boundary of the protective field has an irregular shape. The inner and/or outer boundary of the protective field is in particular defined by extruded polygons and/or triangles of the same shape and/or other polygons. The contour of the space occupied by the robot can be approximated for three-dimensional protective fields, in particular by said extruded polygons and/or triangles of the same shape and/or other polygons. Irregular in particular means that the shape is e.g. not symmetrical or rotationally symmetrical and is not only formed by a cylinder and/or a cuboid, for example.

According to a further embodiment, by removing the space occupied by the robot from the protective field, different protective fields, between which a switching takes place during operation of the robot, are created in different robot positions. For example, a first protective field can therefore be created for a first robot position by removing the space occupied by the robot in the first robot position from the protective field. A second protective field can be generated in the same way for a second robot position. The same procedure can be used for further protective fields and robot positions. It is also possible to use a plurality of robot positions, which are in particular disposed next to one another, for the same protective field. A change in the inner boundary of the protective field therefore takes place between the individual protective fields, as also already mentioned in claim 1. In the operating phases, it is then in each case possible to switch between the protective fields determined for a respective robot position so that an optimum protective field is always used for the current robot position. The advantage then results here that the robot position can be checked even more precisely by means of the protective field. If the robot lags behind, for example due to a delay in its movement, a switch is already made to a protective field that is not yet suitable for the delayed movement. The robot then violates the protective field, whereby the delay can be recognized.

According to a further embodiment, the switching between the different protective fields takes place based on information from a robot control. The information of the robot control can indicate the robot position in which the robot should actually be. As a result, the switching in particular in each case takes place adapted to the currently desired movement speed of the robot. The switching between the different protective fields can then take place based on these data, whereby—as stated above—e.g. a lagging behind or an otherwise incorrect movement of the robot can be recognized.

By switching between different protective fields, a kind of co-moving boundary, i.e. a “bounding box” moving along with the robot, can also be created. The bounding box can be acted on by a buffer zone.

According to a further embodiment, the determination of the space occupied by the robot and the removal of the occupied space from the protective field take place automatically. In particular, all the method steps mentioned herein can take place automatically, i.e. no user intervention is required.

According to a further embodiment, a signal is output when the protective field is violated by the robot (i.e. from “inside”) and/or by another object (e.g. from “outside”), said signal preferably leading to a safety-related measure. The violation of the protective field can be indicated by the signal, whereupon the robot then, for example, slows down, stops or moves around the object that has appeared in the protective field.

A further subject of the invention is a robot system comprising a robot, in particular an articulated arm robot having, for example, six axes, a robot control and a monitoring device, wherein the monitoring device defines a protective field in which the robot moves, wherein the protective field has an outer boundary, wherein
the monitoring device is configured to determine a respective space occupied by the robot for, in particular a plurality of, different robot positions (during the movement of the robot),
the monitoring device is further configured to remove the space occupied by the robot in the respective robot position from the protective field, wherein an inner boundary of the protective field is created and/or changed by removing the occupied space.

The statements regarding the method according to the invention apply accordingly to the robot system according to the invention. It is understood that the method steps mentioned herein can be performed and/or coordinated by the monitoring device and/or the robot control. Said sensor system can, for example, be linked to the monitoring device via a data connection so that measurement data of the sensor system of the monitoring device are available. The monitoring device can in particular carry out all the changes to the protective field, the switching between protective fields, the simulation or detection of the robot movements by the sensor system, and a communication with the robot control. The robot control can perform a safety-related measure in response to a signal of the monitoring device, as stated above. The robot control and the monitoring device can likewise be linked to one another via a data connection.

It is furthermore understood that all the features mentioned herein can be combined with one another, unless explicitly stated otherwise.

The invention will be described purely by way of example with reference to the drawings in the following. There are shown:

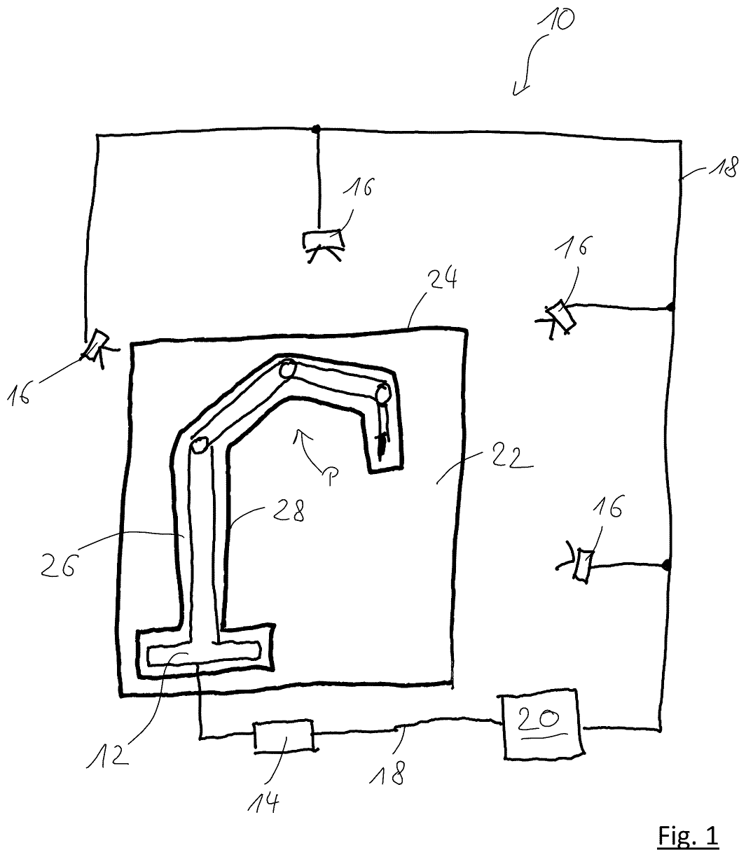

FIG. 1 a robot system in a schematic view; and

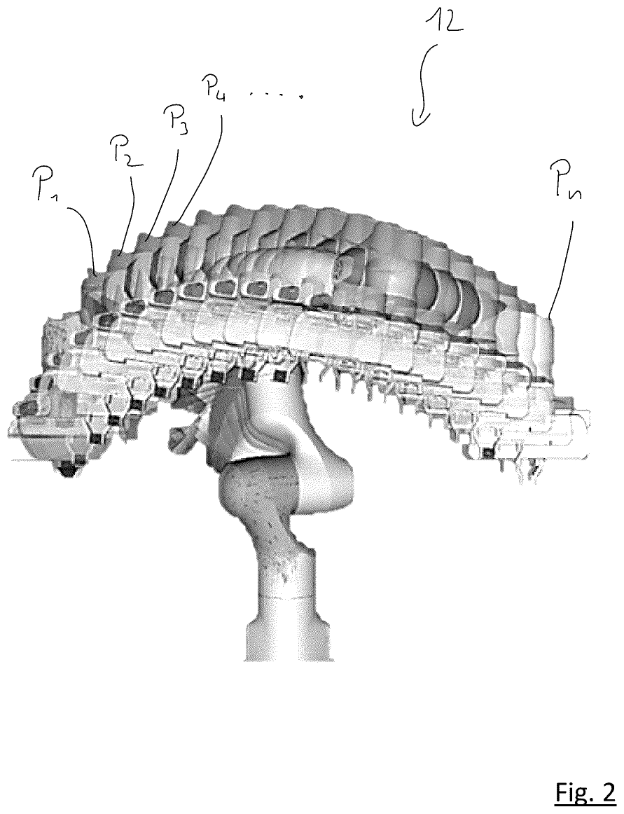

FIG. 2 a robot at different robot positions.

FIG. 1 shows a robot system 10 comprising a robot 12 controlled by a robot control 14. The robot 12 is monitored by a plurality of sensors 16, wherein the sensors are configured as 3D cameras. The robot control 14 and the sensors 16 are connected to a monitoring device 20 via an Ethernet data connection 18.

The robot 12 comprises a plurality of joints so that the robot 12 can assume different positions P.

A protective field 22 that has a cuboid outer boundary 24 is stretched around the robot. The protective field 22 is defined by the monitoring unit 20 and is in particular communicated to the sensors 16 via the Ethernet data connection 18.

Initially, the protective field 22 encompasses the entire space within the outer boundary 24. The robot position P shown in FIG. 1 is now repeatedly determined via the sensors 16 by means of multiple measurement, for which purpose the monitoring device 20 combines the measurement data of the sensors 16.

The monitoring device now determines the space 26 occupied by the robot 12 in the current robot position P from the measurement data of the sensors 16, increases the occupied space 26 slightly and removes the occupied space 26 from the protective field 22. The removal now results in an inner boundary 28 of the protective field 22.

Accordingly, the inner boundary 28 approximately has the shape of the robot 12 in its current pose.

After the space 26 occupied by the robot 12 has now been removed from the protective field 22 for a first robot position P, the removal subsequently also takes place for further robot positions P so that the space located within the inner boundary 28 is increased and is thus adapted to the movement sequences of the robot 12.

Different robot positions P₁-Pₙ are shown in FIG. 2, wherein the occupied space 26 is determined for each of the robot positions shown there and is subtracted from the protective field 22 by the monitoring device 20. Finally, the final protective field is present in the monitoring device 20 and is then used during operation of the robot 12. Alternatively, the monitoring device 20 can also switch between different protective fields 22 during operation.

If a protective field violation is determined by the monitoring device 20 based on the data of the sensors 16 or directly from the sensors 16, the monitoring device 20 transmits a signal to the robot control 14 to effect a safety-related action of the robot 12.

The monitoring device 20 is configured to automatically carry out the change to the protective field based on the respective determined occupied space 26 of the robot 12. In this way, a geometrically complex protective field 22 can be generated that is optimally adapted to the respective movements of the robot 12.

### REFERENCE NUMERAL LIST

10 robot system
12 robot
14 robot control
16 sensor
18 Ethernet connection
20 monitoring device
22 protective field
24 outer boundary
26 occupied space
28 inner boundary
P, P₁-Pₙ robot position

1. A method for monitoring the operation of a robot in a protective field, wherein the protective field has an outer boundary, wherein
a respective space occupied by the robot is determined for different robot positions,
the space occupied by the robot in the respective robot position is removed from the protective field, wherein an inner boundary of the protective field is created and/or changed by removing the occupied space.

2. The method according to claim 1, wherein the robot is an articulated arm robot.

3. The method according to claim 2,
wherein the articulated arm robot has 6 axes.

4. The method according to claim 1,
wherein the robot moves at least partly within the outer boundary of the protective field.

5. The method according to claim 1,
wherein the space occupied by the robot is determined in each case after a predetermined time has elapsed and/or in each case after a change in the robot position by a predetermined value.

6. The method according to claim 1,
wherein the space occupied by the robot between two different robot positions is extrapolated and is also removed from the protective field.

7. The method according to claim 1,
wherein the protective field is monitored by a sensor system that comprises at least one sensor.

8. The method according to claim 7,
wherein the at least one sensor is arranged separately and/or spaced apart from the robot.

9. The method according to claim 7,
wherein the space occupied by the robot is at least partly determined by means of the sensor system.

10. The method according to claim 9,
wherein the space occupied by the robot is at least partly determined by multiple measurement in the same robot position.

11. The method according to claim 1,
wherein the space occupied by the robot is at least partly determined by means of simulation.

12. The method according to claim 11,
wherein the space occupied by the robot is at least partly determined by estimation.

13. The method according to claim 12,
wherein the space occupied by the robot is at least partly determined by means of a Kalman filter.

14. The method according to claim 1,
wherein the space occupied by the robot is increased after it has been determined, wherein the increased space is removed from the protective field
or
wherein the increased space is used as a new outer boundary of the protective field.

15. The method according to claim 14,
wherein the space occupied by the robot is increased by a stretching.

16. The method according to claim 14,
wherein the space occupied by the robot is increased by an isotropic stretching,

17. The method according to claim 1,
wherein the inner and/or the outer boundary of the protective field has an irregular shape.

18. The method according to claim 17,
wherein the irregular shape is defined by extruded polygons and/or triangles of the same shape and/or other polygons.

19. The method according to claim 1,
wherein, by removing the space occupied by the robot from the protective field, different protective fields, between which a switching takes place during operation of the robot, are created in different robot positions.

20. The method according to claim 19,
wherein the switching takes place based on information from a robot control.

21. The method according to claim 1,
wherein the determination of the space occupied by the robot and the removal of the occupied space from the protective field take place automatically.

22. The method according to claim 1,
wherein a signal is output when the protective field is violated by the robot and/or by another object.

23. The method according to claim 22,
wherein the signal leads to a safety-related measure.

24. A robot system comprising a robot, a robot control and a monitoring device, wherein the monitoring device defines a protective field in which the robot moves, wherein the protective field has an outer boundary, wherein
the monitoring device is configured to determine a respective space occupied by the robot for different robot positions,
the monitoring device is configured to remove the space occupied by the robot in the respective robot position from the protective field, wherein an inner boundary of the protective field is created and/or changed by removing the occupied space.
